(19) United States
(12) Patent Application Publication
(10) Pub. No.: US 2009/0227311 A1
(43) Pub. Date: Sep. 10, 2009

(54) POKER GAMING MACHINE AND POKER GAME PLAYING METHOD

(75) Inventor: Fumio NAKANO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/257,001

(22) Filed: Oct. 23, 2008

Related U.S. Application Data
(60) Provisional application No. 61/035,160, filed on Mar. 10, 2008.

(51) Int. Cl. A63F 9/24; A63F 13/00

(52) U.S. Cl. 463/13

(57) ABSTRACT

A poker gaming machine executes a poker game employing cards including trump cards and a special card. The special card functions as a wild card with respect to a specific type trump card. The specific type trump card is a trump card constituting one portion of card types from all types of trump card. If the special card is included in the player's hand, the poker gaming machine regards the special card as a specific type trump card and makes a judgment with respect to establishment of a poker combination.

### CROSS-REFERENCE TO RELATED APPLICATIONS

This application is based upon and claims a priority from the U.S. provisional Patent Application No. 61/035160 filed on Mar. 10, 2008, the entire contents thereof are incorporated herein by reference.

### BACKGROUND

1. Technical Field

The poker gaming machine and poker game playing method according to one or more aspects of the present invention relates to a poker game and a poker game playing method employing cards including a trump card. More particularly, it relates to a poker game and a poker game playing method offering new game characteristics.

2. Description of Related Art

Conventionally, poker gaming machines and tables at which a poker game is carried out are installed in a gaming hall, etc. These poker gaming machines and tables employ trump cards to which one number and a suit are respectively allocated. A poker game is thus desired which offers new game characteristics.

The present invention provides a poker gaming machine and a poker game playing method that enable a poker game that offers game characteristics which could not be successfully achieved in the conventional art and can attract the players even more.

### SUMMARY

A poker gaming machine according to one or more aspects of the present invention executes a poker game in which trump cards are used. The poker gaming machine has a display and a processor. Upon accepting a bet of a gaming value placed by a player, the processor determines a player's hand from a card group including trump cards and a special card. The processor determines whether or not the player's hand constitutes a poker combination. Here, in a case where the special card is included in the player's hand, the processor judges whether or not the player's hand constitutes a poker combination on supposition that the special card is the specific type trump card constituting a portion of all card types of the trump cards. If the player's cards constitute a poker combination, the processor awards a prize corresponding to the established poker combination. Employment of the special card in this poker gaming machine can offer new game characteristics that could not be successfully achieved in the conventional poker game.

According to the present invention encompassing one or more aspects, there is provided a poker gaming machine that executes a poker game in which trump cards are used. The poker gaming machine comprises a display and a processor. Upon accepting a bet of a gaming value placed by a player, the processor determines a player's hand from a card group including trump cards and a special card. The processor determines whether or not the player's hand constitutes a poker combination. Here, in a case where the special card is included in the player's hand, the processor judges whether or not the player's hand constitutes a poker combination on supposition that the special card is the specific type trump card with any of characters “J”, “Q” and “K”. If the player's cards constitute a poker combination, the processor awards a prize corresponding to the established poker combination. Employment of the special card in this poker gaming machine can offer new game characteristics that could not be successfully achieved in the conventional poker game.

According to the present invention encompassing one or more aspects, there is provided a poker game playing method. The poker game is played by cards including trump cards. Upon accepting a bet of a gaming value placed by a player, a player's hand is determined from a card group including trump cards and a special card. A determination is made with respect to whether or not the player's hand constitutes a poker combination. Here, in a case where the special card is included in the player's hand, the determination is made with respect to whether or not the player's hand constitutes a poker combination on supposition that the special card is the specific type trump card constituting a portion of all card types of the trump cards. If the player's cards constitute a poker combination, the player is awarded a prize corresponding to the established poker combination. Employment of the special card in this poker game playing method can offer new game characteristics that could not be successfully achieved in the conventional poker game.

According to the present invention encompassing one or more aspects, there is provided a poker game playing method. The poker game is played by cards including trump cards. Upon accepting a bet of a gaming value placed by a player, a player's hand is determined from a card group including trump cards and a special card. A determination is made with respect to whether or not the player's hand constitutes a poker combination. Here, in a case where the special card is included in the player's hand, the determination is made with respect to whether or not the player's hand constitutes a poker combination on supposition that the special card is the specific type trump card with any of characters “J”, “Q” and “K”. If the player's cards constitute a poker combination, the player is awarded a prize corresponding to the established poker combination. Employment of the special card in this poker game playing method can offer new game characteristics that could not be successfully achieved in the conventional poker game.

### BRIEF DESCRIPTION OF THE DRAWINGS

FIG. 1 is an explanatory diagram showing characteristics of a poker game according to one embodiment of the present invention;

FIG. 2 is a perspective view showing an outer appearance of a poker gaming machine according to one embodiment of the present invention;

FIG. 3 is a block diagram showing a control system of the poker gaming machine according to one embodiment of the present invention;

FIG. 4 is an explanatory diagram showing one example of a special card according to one example of the present invention;

FIG. 5 is a flow chart of a main control program of the poker gaming machine according to one embodiment of the present invention;

FIG. 6 is a flow chart showing a main game process program of the poker gaming machine according to one embodiment of the present invention;

FIG. 7 is a flow chart of a bet process program of the poker gaming machine according to one embodiment of the present invention;

FIG. 8 is a flow chart of a deal process program of the poker gaming machine according to one embodiment of the present invention;

FIG. 9 is an explanatory diagram showing one example of a deal screen;

FIG. 10 is an explanatory diagram showing one example of a card content display screen;

FIG. 11 is a draw process program of the poker gaming machine according to one embodiment of the present invention;

FIG. 12 is an explanatory diagram showing one example of a hold screen;

FIG. 13 is an explanatory diagram showing a relationship between cards that are dealt in the deal process program and cards that are changed in the draw process program;

FIG. 14 is a flow chart of a poker combination judgment process program of the poker gaming machine according to one embodiment of the present invention;

FIG. 15 is an explanatory diagram showing one example of a payout table showing poker combinations and associated payouts in the poker game;

FIG. 16 is an explanatory diagram showing one example of a game result screen;

FIG. 17 is an explanatory diagram showing one example of a special card content judgment table; and

FIG. 18 is a view of a frame format showing an example in which the present invention is applied to a table game.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Next, a detailed description will be given with respect to a poker gaming machine according to the present invention, as embodied in a poker gaming machine 1 according to this embodiment, while referring to the accompanying drawings.

First, characteristics of the poker game in the poker gaming machine 1 will be described while referring to the accompanying drawings, according to one embodiment of the present invention. The poker gaming machine 1 carries out a video poker game. Specifically, the poker gaming machine 1 carries out a draw poker game using trump cards, by displaying the cards on a display (hereinafter referred to as a lower image display panel 6).

More specifically, when a player places a bet of a gaming value, a player's hand constituted of five cards will be dealt to the player. Then, the player selects the cards he/she will hold (cards that will remain in his/her hand), from amongst the cards that make up the player's hand. The cards which are held by the player remain as cards making up the player's hand. Alternatively, the cards, from the player's hand, that were not held are drawn (replaced) for new cards. The decision on whether to hold or draw is arbitrarily made by the player. If the player's hand constitution is established, a judgment is made as to whether the player's hand establishes a predetermined poker combination (for instance, “FLUSH”, “TWO PAIR” or the like). If a poker combination has been established, the player is awarded a prize corresponding to the poker combination.

Here, the poker gaming machine 1 according to one embodiment of the present invention uses a special card 100, in addition to the regular trump cards. Here, the regular trump cards are each allotted a number from thirteen types of numbers (e.g., “A”, “2” . . . “10”, “J”, “Q”, “K”) and one suit from four types of suits (e.g., “spades”, “diamonds”, “clubs” and “hearts”). The special card 100 represents a wild card with respect to a specific type card, from amongst the cards constituting the trump cards.

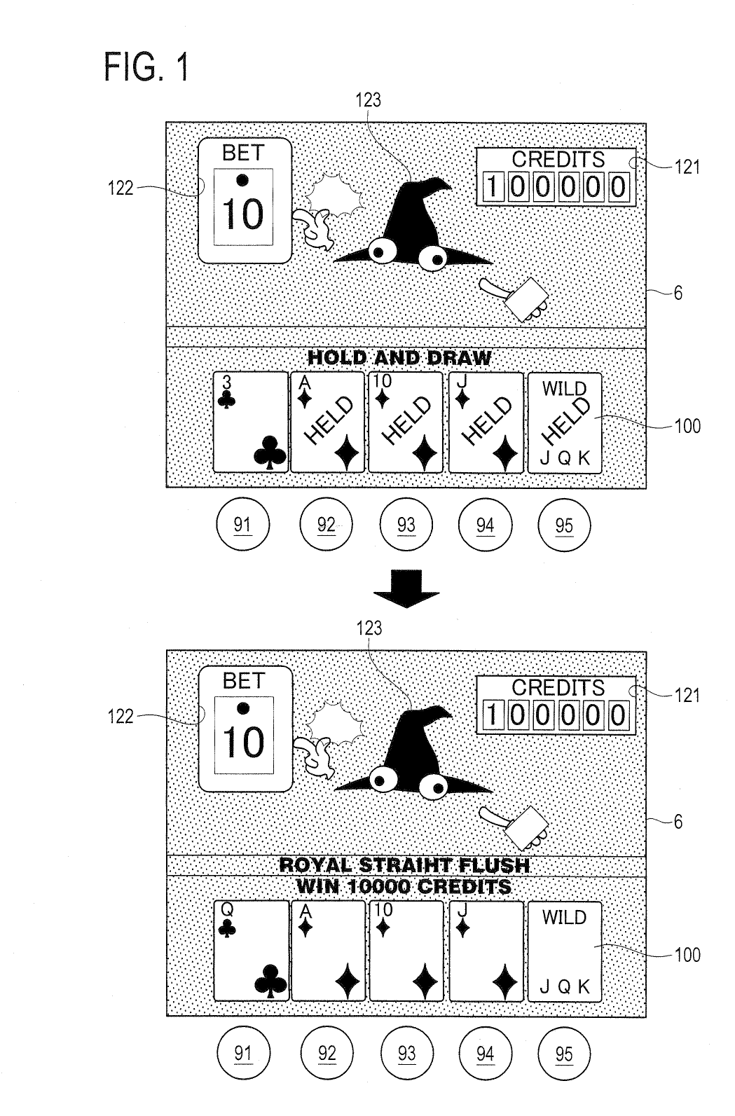

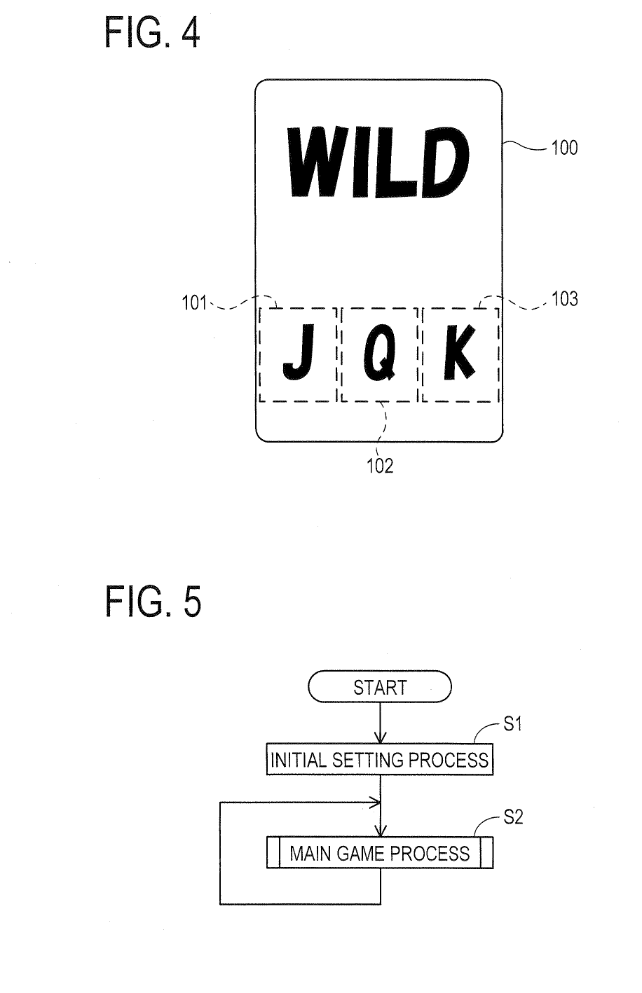

This special card 100 has a first card type display portion 101 through a third card type display portion 103 (refer to FIG. 4). That is, if the special card 100 is included in the player's hand, the special card 100 is regarded as a trump card having certain numbers displayed on the first card type display portion 101 through the third card type display portion 103 (for instance, in the case of FIG. 1, “J”, “Q” and “K”) and four types of suites. If the poker combination is established in the player's hand including this special card 100, as well, the player is awarded a prize corresponding to the poker combination.

That is to say, the poker gaming machine 1 offers new interest in the poker game by providing the possibility that a special card 100 might be included in the player's hand. More specifically, the poker gaming machine 1 offers new strategy characteristic with respect to holding and drawing cards in the poker game.

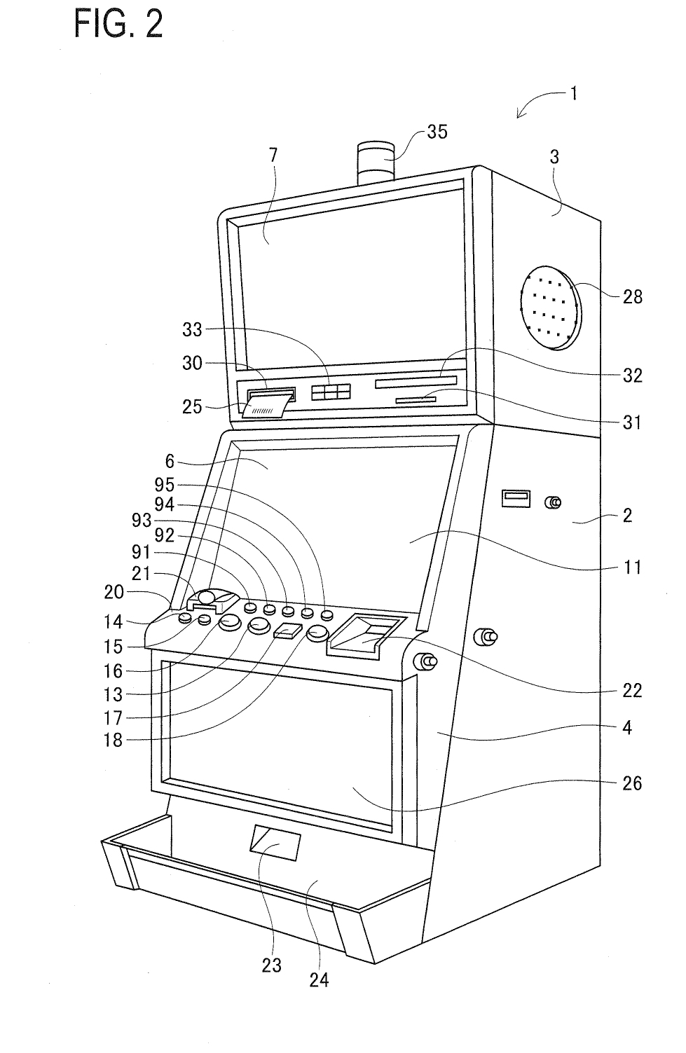

Next, a schematic configuration of the poker gaming machine 1 will be described in detail while referring to the drawings, according to one embodiment of the present invention. FIG. 2 is a perspective view showing an outer appearance of the poker gaming machine according to one embodiment of the present invention.

The poker gaming machine 1 has a cabinet 2, a top box 3 and a main door 4. The cabinet 2 houses various devices required for controlling the poker gaming machine 1. The cabinet 2 houses a motherboard 40 and the like as will be described later. The top box 3 is installed on an upper side of the cabinet 2. The main door 4 is provided at a front face of the cabinet 2.

The top box 3 has an upper image display panel 7 at a front face thereof. The upper image display panel 7 is constituted of a heretofore known transparent liquid crystal panel. The upper image display panel 7 displays a demonstration image and information concerning games in the poker gaming machine 1. The information concerning games in the poker gaming machine 1 includes information on the game rules, payout tables and the like.

The main door 4 has a lower image display panel 6 at a front face thereof. The lower image display panel 6 is constituted of a heretofore known transparent liquid crystal panel. The lower image display panel 6 displays game contents of the video poker (draw poker) game carried out in the poker gaming machine 1.

A control panel 20, a coin insertion portion 21 and a bill identifier device 22 are installed at a lower side of the lower image display panel 6. The control panel 20 has a plurality of buttons used by the player to carry out various operations. More specifically, the control panel 20 has a START button 13, a CHANGE button 14, a CASHOUT button 15, a 1-BET button 16, a MAX-BET button 17, a CARD-EXCHANGE button 18, a first hold button 91, a second bold button 92, a third hold button 93, a fourth hold button 94 and a fifth hold button 95.

The START button 13 is operated to receive a player's hand deal, the player's hand being constituted of five cards. The CHANGE button 14 is operated to require exchange of money from the staff at the gaming hall. The CASHOUT button 15 is operated to receive a coin payout (1 credit corresponds to 1 coin) with respect to a coin tray 24, in accordance with a credit amount that the player possesses, or to receive a payout of bar code tickets 25 as will be described later.

The 1-BET button 16 is operated to bet 1 credit in the game, from amongst the credits that the player possesses. The MAX-BET button 17 is operated to bet a maximum credit amount (in the present embodiment, 40 credits) which can be betted in one game, from the credits that the player possesses.

The first hold button 91 through the fifth hold button 95 are operated to hold (keep in hand) the trump cards that the player has judged as necessary, from amongst the five cards that have been dealt. The CARD-EXCHANGE button 18 is operated to draw (replace) the trump card(s) that was/were judged as unnecessary for a new trump card(s).

The coin insertion portion 21 is adapted for insertion of coins representing gaming media inside the cabinet 2. The coin insertion portion 21 has a reverter 21S and a coin counter 21C provided inside (refer to FIG. 2). The reverter 21S identifies the adequacy of the coins inserted into the coin insertion portion 21 and then discharges coins other than regular coins from a coin payout port 23. The coin counter 21C detects the regular coins that were inserted and counts them.

The bill identifier device 22 identifies the adequacy of the bills and at the same time inserts the regular bills in the cabinet 2. The bills that were inserted inside the cabinet 2 are converted into number of coins. The credits corresponding to the number of coins thus converted are added up as the credits that the player possesses. The bill identifier device 22 is configured so as to enable read out of the bar code ticket 25 as will be described later.

A lower panel 26 with a character of the poker gaming machine 1 and the like being depicted is installed at a lower side of the control panel 20.

The poker gaming machine 1 according to the present embodiment employs coins, bills or electronic value information (credits) corresponding to these, as gaming values. The gaming values applicable to the present invention are not limited to those described above. In the present invention, the gaming values can include, for instance, medals, tokens, electronic money and tickets.

A ticket printer 30, a card reader 31, a data display device 32 and a keyboard 33 are installed at a lower side of the upper image display panel 7.

Here, the ticket printer 30 serves as a printer that outputs a bar code ticket 25 onto which the bar code has been printed. The bar code of this bar code ticket 25 is generated by encoding data such as the credit amount, date, identification number of the poker gaming machine 1 and the like. The player can use thus outputted bar cord ticket 25 in various purpose.

The card reader 31 performs data read out and data write with respect to a smart card that the player possesses. This smart card is a card that stores data with respect to the player's game history.

The data display device 32 is constituted of a fluorescent display and the like. For instance, the data display device 32 displays data that was read out by the card reader 31 and data that was input by the player using the keyboard 33. The keyboard 33 is employed to input commands and data with respect to ticket issuance and the like. Further, the top box 3 has a lamp 35 provided on an upper face thereof. The lamp 35 lights up in a predetermined lighting fashion when a clerk, etc. at the game hall is called. For instance, if an error has occurred in the poker gaming machine 1, the lamp 35 lights up in a predetermined lighting fashion.

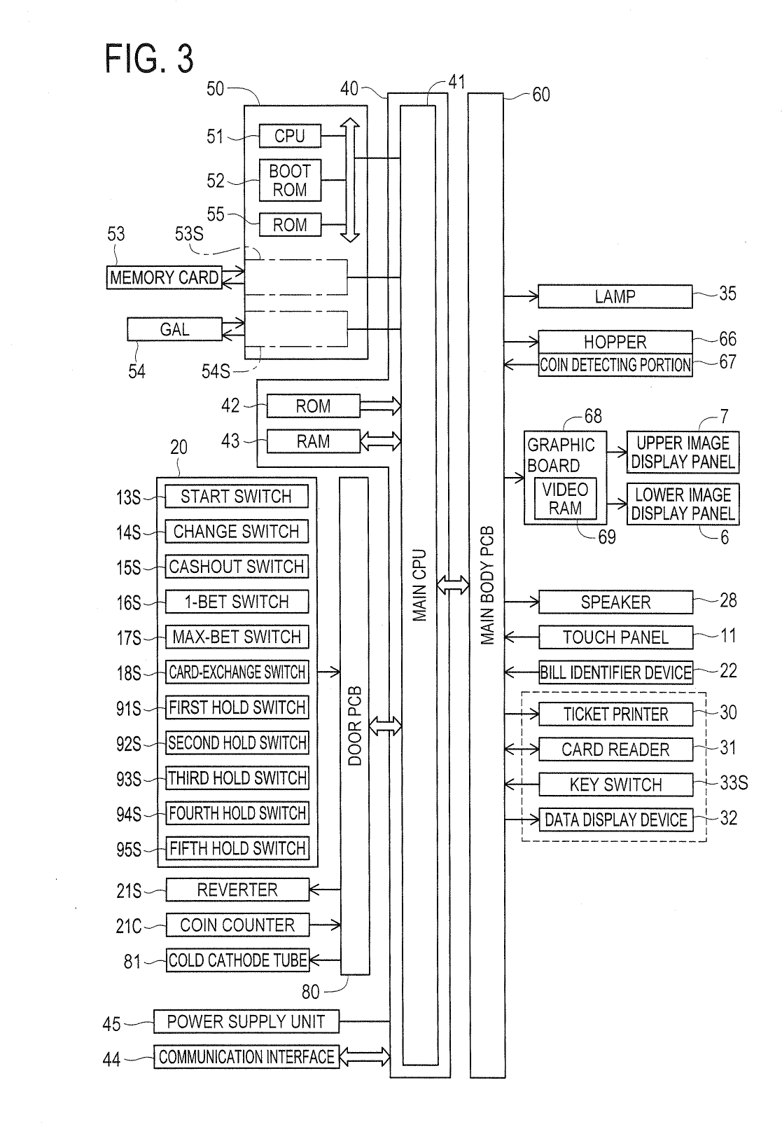

Next, a configuration of a control system in the poker gaming machine 1 will be described in detail while referring to the drawings. FIG. 3 is a block diagram showing a control system of the poker gaming machine 1.

As shown in FIG. 3, the control system of the poker gaming machine 1 is basically made up of a motherboard 40 and a gaming board 50.

First, the gaming board 50 will be described. The gaming board 50 has a CPU 51, a ROM 55 and a ROM 52 connected together by an internal bus, and a card slot 53 corresponding to the memory card 53, and an IC socket 54S corresponding to the GAL (Generic Array Logic) 54.

The memory card 53 is a recording medium that stores a game program and a game system program (hereinafter referred to as game programs). The memory card 53 is made up of a non-volatile memory. The game programs stored in the memory card 53 include a lottery program. This lottery program is executed at the time of determining the five cards which are dealt and displayed and the five cards which are drawn (replaced) and then displayed once again. The lottery program includes symbol weighing data. The symbol weighing data corresponds to a plurality of types of payout rates (for instance, 80%, 84% and 88%).

The payout rate is set based on the payout rate setting data which is outputted from the GAL 54. The lottery for the player's hand is carried out based on the symbol weighing data corresponding to the payout rate thus set.

The card slot 53S is configured so as to enable insertion and removal of the memory card 53. The card slot 53S is connected to the motherboard 40 through an IDE bus. Accordingly, a manager of the poker gaming machine 1 can change the type and contents of the game by rewriting the game programs stored in the memory card 53. The manager can also change the type and contents of the game carried out in the poker gaming machine 1 by switching the memory card for a memory card 53 that stores different game programs.

The game programs include image data such as game rules and payout tables and the like, and demonstrations images, in addition to a program concerning the progress of the game, the image data and the audio data, etc. which are outputted during the game.

The GAL 54 is one type of PLD and has an OR fixed-type array configuration. The GAL 54 has a plurality of input ports and output ports. Upon receiving predetermined data at its input ports, the GAL 54 outputs data corresponding to the input data, from its output ports. Specifically, the payout rate setting data as described above is outputted from the output ports of the GAL 54.

The IC socket 54S is configured so as to allow quick connection and disconnection of the GAL 54. The IC socket 54S is connected to the motherboard 40 through the PCI bus. Accordingly, the manager and the like of the poker gaming machine 1 can change the payout rate setting data which will be outputted from the GAL 54 by rewriting to the GAL 54 or by replacing the GAL 54 itself.

The CPU 51, the ROM 55 and the boot ROM 52 which are connected with one another through the internal bus are, in turn, connected with the motherboard 40 through the PCI bus. The PCI bus carries out signal transmission between the motherboard 40 and the gaming board 50. The PCI bus supplies power from the motherboard 40 to the gaming board 50. The ROM 55 stores country identification information and an authentication program. The boot ROM 52 stores a preliminary authentication program and a boot code and the like. The boot code is a program that causes the CPU 51 to activate the preliminary authentication program.

The authentication program serves to authenticate the game programs (e.g., falsification check program). The authentication program will be further described while referring to the falsification check procedure of the game programs that will be subjected to the authentication take-in process. The preliminary authentication program is a program that authenticates the above-described authentication program. The preliminary authentication program will be described while referring to the falsification check procedure of the authentication program that will be subjected to the authentication process.

Next, the motherboard 40 will be described. The motherboard 40 is configured of a commercially available general purpose motherboard (printed circuit board onto which basic components of a personal computer are mounted). Specifically, the motherboard 40 has a main CPU 41, a ROM 42, a RAM 43 and a communication interface 44.

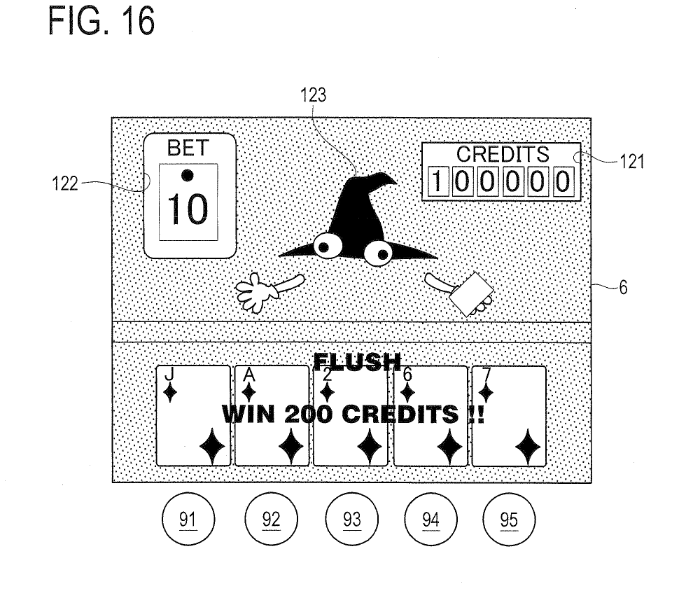

The ROM 42 is configured of a memory device such as a flash memory or the like. The ROM 42 stores programs such as BIOS or the like which are executed in the main CPU 41 and permanent data such as payout tables or the like (refer to FIG. 15). As a result of executing the BIOS in the main CPU 41, predetermined periphery devices are initialized. Then, a take-in process of the game programs stored in the memory card 53 is started through the gaming board 50.

The RAM 43 stores data and programs to be used when the main CPU 41 operates. The RAM 43 stores a variety of programs such as authentication programs and game programs which are read out through the gaming board 50 and a variety of information such as credit amount that the player currently possesses and the like.

The communication interface 44 is a communication device that carries out communication between the servers which have been installed inside the gaming hall, through a communication line. The poker gaming machine 1 can communicate information concerning the game amongst the servers through the communication interface 44 as well. For instance, the poker gaming machine 1 is configured so as to allow communication of bet information with the servers as will be described later, whereby a portion of the gaming values that betted can be accumulatively added up. In this case, the poker gaming machine 1 can award a progressive payout to the players, as a payout for a poker combination.

The motherboard 40 connects the main body PCB 60 and the door PCB 80, that will be described later, through a USB. Further, the motherboard 40 is connected with a power supply unit 45. The main CPU 41 of the motherboard 40 is activated once power is supplied from the power supply unit 45 to the motherboard 40. Further, the CPU 51 is activated by power supply to the gaming board 50 through the PCI bus.

The main body PCB 60 and the door PCB 80 are connected to device and apparatuses that generate an input signal with respect to the main CPU 41, and devices and apparatuses whose operation is controlled by a control signal from the main CPU 41. The main CPU 41 executes the game programs stored in the RAM 43, based on the input signal inputted to the main CPU 41. The main CPU 40 executes process to store the computation process in the RAM 43 and control process onto each device and apparatus by executing a predetermined computation process.

The main body PCB 60 is connected to the lamp 35, a hopper 66, a coin detecting portion 67, a graphic board 68, a speaker 28 (refer to FIG. 2), a touch panel 11, a bill identifier device 22, a ticket printer 30, a card reader 31, a key switch 33S and a data display device 32.

Here, the touch panel 11 is installed at a front face of the lower image display panel 6. Accordingly, the poker gaming machine 1 can identify the coordinate position of the portion on the touch panel 11 that was touched by the player. Based on the coordinate position information thus identified, the poker gaming machine 1 can judge the location of the portion that the player touched and further, in what direction the touched part has moved.

The hopper 66 is installed inside the cabinet 2. The hopper 66 pays out a predetermined number of coins from the coin payout port 23 to the coin tray 24, based on the control signal from the main CPU 41. The coin detecting portion 67 is installed inside the coin payout port 23. Once it is detected that a predetermined number of coins has been paid out from the coin payout port 23, the coin detecting portion 67 outputs an input signal to the main CPU 41.

The graphic board 68 controls the image display on the upper image display panel 7 and the lower image display panel 6 based on a control signal from the main CPU 41.

Here, the graphic board 68 has a VDP (Video Display Processor) and a video RAM 69 and the like. The VDP generates image data based on the control signal from the main CPU 41. The video RAM 69 temporarily stores image data generated by the VDP. The image data employed by the VDP to generate image data is included in the game program.

The bill identifier device 22 identifies the adequacy of the bills and bar code ticket 25. Further, the bill identifier device 22 inserts the regular bills and bar code tickets 25 inside the cabinet 2. When the regular bills have been inserted, the bill identifier device 22 outputs an input signal to the main CPU 41 based on the amount of the bills. Similarly, if a regular bar code ticket 25 has been inserted, the bill identifier device 22 outputs an input signal to the main CPU 41 based on the number of coins which have been recorded on the bar code ticket 25.

The ticket printer 30 outputs a bar code ticket 25 based on the control signal outputted from the main CPU 41. Specifically, the ticket printer 30 prints, on a ticket, a bar code obtained by encoding data such as credit amount and the like, which has been stored in the RAM 43.

The card reader 31 reads out data from the smart card and then transmits this data to the main CPU 41. The card reader 31 writes data to the smart card based on the control signal from the main CPU 41. The key switch 33S is installed on the keyboard 33. When the keyboard 33 is operated by the player, the key switch 33 outputs a predetermined input signal to the main CPU 41. The data display device 32 displays data read out by the card reader 31 and data that was inputted via the keyboard 33, based on the control signal to be outputted from the main CPU 41.

On the other hand, the door PCB 80 is connected with a control panel 20, a reverter 21S, a coin counter 21C and a cold cathode tube 81. The control panel 20 has a START switch 13S, a CHANGE switch 14S, a CASHOUT switch 15S, a 1-BET switch 16S, a MAX-BET switch 17S, a CARD-EXCHANGE switch 18S, a first hold switch 91S, a second hold switch 92S, a third hold switch 93S, a fourth hold switch 94S and a fifth hold switch 95S.

The START switch 13S corresponds to the START button 13. The CHANGE switch 14S corresponds to the CHANGE button 14. The CASHOUT switch 1SS corresponds to the CASHOUT button 15. The 1-BET switch 16S and the MAX-BET switch 17S correspond to the 1-BET button 16 and the MAX-BET button 17, respectively. The CARD EXCHANGE switch 18S corresponds to the CARD EXCHANGE button 18. The first hold switch 91S through the fifth hold switch 95S correspond to the first hold button 91 through the fifth hold button 95, respectively.

These switches each output an input signal to the main CPU 41 when the corresponding button has been operated by the player.

The coin counter 21C is provided inside the coin insertion portion 21. The coin counter 21C identifies the adequacy of the coins that were inserted in the coin insertion portion 21 by the player. Based on the identification results by the coin counter 21C, the poker gaming machine 1 discharges irregular coins from the coin payout port 23. If a regular coin has been detected, the coin counter 21C outputs an input signal to the main CPU 41.

The reverter 21S operates based on the control signal which is outputted from the main CPU 41. The reverter 21S sorts out the coins that were recognized as regular coins by the coin counter 21C into a cash box (not shown) or the hopper 66 installed inside the poker gaming machine 1. The cold cathode tube 81 is provided at a back surface side of the lower image display panel 6 and the upper image display panel 7. The cold cathode tube 81 functions as a back light of the lower image display 6 and the upper image display panel 7 by lighting up based on the control signal from the main CPU 41.

Next, the procedure of the poker game in the poker gaming machine 1 will be described in detail while referring to the drawings.

First, the cards which are employed in the poker gaming machine 1 will be described. As was described earlier, the poker game in the poker gaming machine 1 employs trump cards and a special card 100.

Basically, one trump card has one “number” and one “suit”. The “number” refers to the number given to the trump cards. This “number” includes thirteen types of numbers. Specifically, the “number” includes A (Ace, corresponds to 1), 2, 3, 4, 5, 6, 7, 8, 9, 10, J (Jack, corresponds to 11), Q (Queen, corresponds to 12) and K (King, corresponds to 13). The “suit” refers to the mark given to the trump cards. This “suit” includes four types of marks. Specifically, the “suit” includes spades, hearts, diamonds and clubs. The type of a trump card is basically identified by a combination of the “number” and “suit”.

Next, the special card 100 which is used in the poker game in the poker gaming machine 1 will be described in detail while referring to the drawings. FIG. 4 is an explanatory diagram with respect to a special card 100. The special card 100 is a wild card with respect to a specific type card constituting one portion of the trump cards. Then, as shown in FIG. 4, the special card 100 has a first card type display portion 101, a second card type display portion 102 and a third card type display portion 103.

The first card type display portion 101 displays one number from amongst thirteen types of numbers for the trump cards. The number displayed on the first card type display portion 101 shows the type of trump card with respect to which the special card 100 functions as a wild card. For instance, in the case shown in FIG. 4, the special card 100 is regarded, in the poker combination judgment process (S15) as will be described later, as a trump card having number “J” and four types of “suits (e.g., spades, diamonds, clubs or hearts)”. The type of the trump card which is identified by the number shown on the first card type display portion 101 is referred to as a “first card type”.

As is the case with the first card type display portion 101, the second card type display portion 102 and the third card type display portion 103 as well show one number from amongst the thirteen types of numbers for the trump cards. The number displayed on the second card type display portion 102 and the third card type display portion 103 as well shows the type of trump card with respect to which the respective special card 100 functions as a wild card. The type of the trump card which is identified by the number shown on the second card type display portion 102 is referred to as a “second card type”. Similarly, the type of the trump card which is identified by the number shown on the third card type display portion 103 is referred to as a “third card type”.

Accordingly, the special card 100 functions as a wild card with respect to twelve types of trump cards in the poker combination judgment process (S15). Specifically, the special card 100 functions as a “trump card having a certain number displayed on the first card type display portion 101 through the third card type display portion 103 and one of four types of suits” in the poker combination judgment process (S15).

In the poker gaming machine 1, the special card 100 is initially set to “first card type: J”, “second card type: Q” and “third card type: K”. Accordingly, the special card 100 has the contents shown in FIG. 4 until a change condition as will be described later is established.

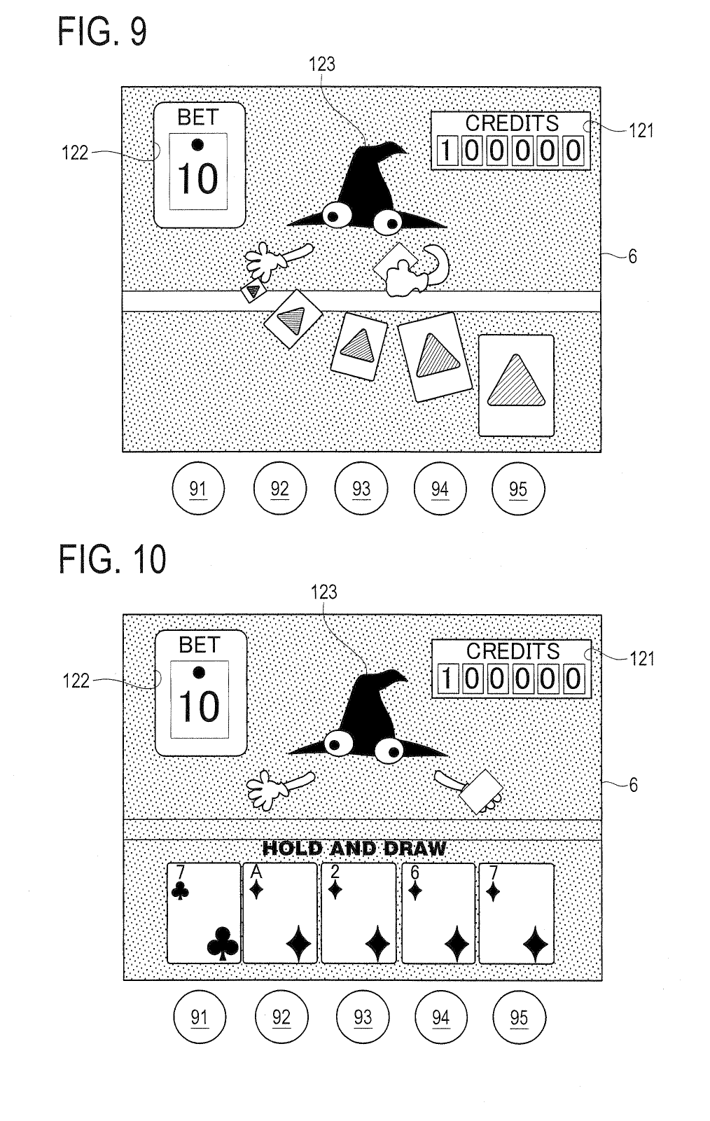

The flow of the poker game in the poker gaming machine 1 will now be described. To play a poker game in the poker gaming machine 1, the player inserts coins in the coin insertion portion 21 and adds up the credits as gaming values. At this time, the credit amount display portion 121 of the lower image display panel 6 shows the credit amount that the player possesses (refer to FIG. 9). Then, the player bets credits he/she possesses in one poker game (hereinafter referred to as a unit game) by operating the 1-BET button 16, etc. At this time, the bet amount display portion 122 of the lower image display panel 6 displays the credit amount that was bet in a unit game. Then, once the player depresses the START button 13, the poker game is started. At this time, the lower image display panel 6 displays a character image 123. This character image 123 is displayed as a dealer in the poker game.

Thereafter, in the poker gaming machine 1, five cards constituting a player's hand are dealt to the players (S12). The five cards that constitute a player's hand are determined from a deck including trump cards and a special card 100. At this time, the lower image display panel 6 displays a deal screen (refer to FIG. 9). The deal screen displays an animated image in which a character image 123 deals cards constituting a player's hand.

Once dealing of the player's hand is ended, the lower image display panel 6 displays a card content display screen (FIG. 10). The card content display screen displays contents of the cards that constitute a player's hand. Specifically, the number and suit of the cards constituting the player's hand are displayed on the lower image display panel 6 (refer to FIG. 10).

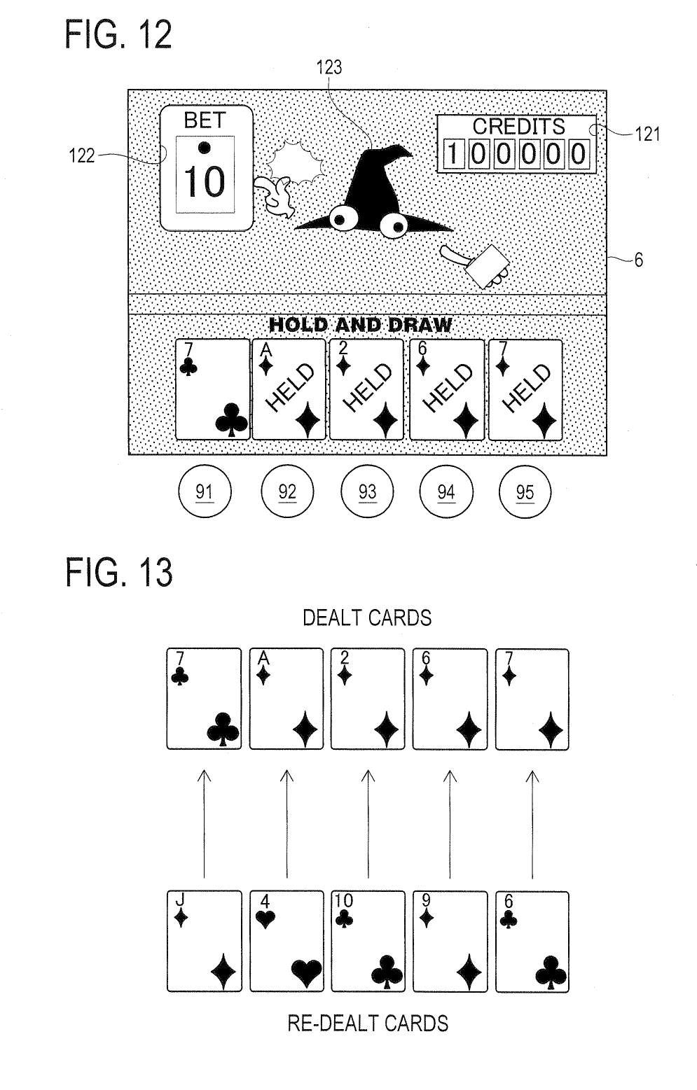

After confirming the contents of the player's hand, the player holds and draws a card(s) constituting the player's hand. Specifically, the player uses the first hold button 91 through the fifth hold button 95 to select the cards that will remain in hand, from the cards constituting the player's hand. Here, the operation of selecting the card(s) that will remain in hand, from the 5 cards in the player's hand is referred to as a “hold operation”. At this time, the lower image display panel 6 displays the character string “HELD” on each of the cards that were selected as cards that will remain in hand (refer to FIG. 12).

Once the hold operation is ended, the cards which have not been selected in the hold operation are drawn (replaced) again for new cards. This card draw determines the configuration of a player's hand in the current unit game. The user can thus arbitrarily hold and draw cards. That is to say, the player can also determine the configuration of the player's hand without holding or drawing cards.

The first hold button 91 through the fifth hold button 95 are arranged immediately below the five cards that constitute the player's hand. The first hold button 91 through the fifth hold button 95 are each associated with the card positioned immediately above. Accordingly, the player intuitively grasps which button to operate to hold the desired card.

Then, the poker gaming machine 1 judges whether or not the poker combination has been established based on the constitution of the player's hand thus set (S15). If the player's hand includes a special card 100, the poker gaming machine 1 regards the special card 100 as a trump card which is identified by the display on the first card type display portion 101 through the third card type display portion 103. Then, the poker gaming machine 1 judges whether or not the poker combination has been established. If the player's hand constitutes a poker combination, the player is awarded a prize based on the poker combination thus established and the amount of gaming values that were bet (S17). The lower image display panel 6 displays a game result screen (refer to FIG. 16). The lower image display panel 6 notifies to the player whether the poker combination has been established by displaying the game result screen. If the poker combination has been established, the lower image display panel 6 notifies to the player the poker combination thus established and the contents of the payout that will be awarded, in the game result screen. After the prize payout is ended, the unit game for the poker game is ended.

If a predetermined change condition as will be described later is established in the unit game, the special card content change process (S19) is carried out. In the special card content change process (S19), the poker gaming machine 1 changes the type of the trump card with respect to which the special card 100 functions as a wild card.

Next, a main control program in the poker gaming machine 1 will be described in detail while referring to the drawings. FIG. 5 is a flow chart of a main control program. In the poker gaming machine 1 in the description to follow, the memory card 53 is already inserted in the card slot 53S. The GAL 54 is mounted in the IC socket 54S.

Once the power supply switch is turned on (upon power on) in the power supply unit 45, the poker gaming machine 1 executes an initial setting process (S1). In this initial setting process (S1), first, the motherboard 40 and the gaming board 50 are each activated. Then, the motherboard 40 and the gaming board 50 separately execute an authentication readout in parallel.

In more detail, in the gaming board 50, the CPU 51 reads out a preliminary authentication program which is stored in the boot ROM 52. Then, the CPU 51 carries out a preliminary authentication in accordance with the preliminary authentication program thus read out. In this preliminary authentication, the CPU 51 confirms and certifies that the authentication program has not been falsified. The preliminary authentication is carried out before the authentication program is taken in in the motherboard 40.

On the other hand, in the motherboard 40, the main CPU 41 executes the BIOS stored in the ROM 42. Then, the main CPU 41 expands the compressed data incorporated in the BIOS into the RAM 43, and executes the BIOS. The main CPU 41 then carries out a diagnosis and initialization of t the various peripheral devices.

Thereafter, the main CPU 41 reads out the authentication program stored in the ROM 55. Then, the main CPU 41 authenticates the game programs stored in the memory card 53 based on the authentication program. In this authentication, the main CPU 41 confirms and certifies that the game programs have not been falsified. If this authentication process ends normally, the main CPU 41 writes the game programs authenticated in the RAM 43 and acquires payout rate setting data and country identification information. As a result, the initial setting process (S1) in the poker gaming machine 1 is ended.

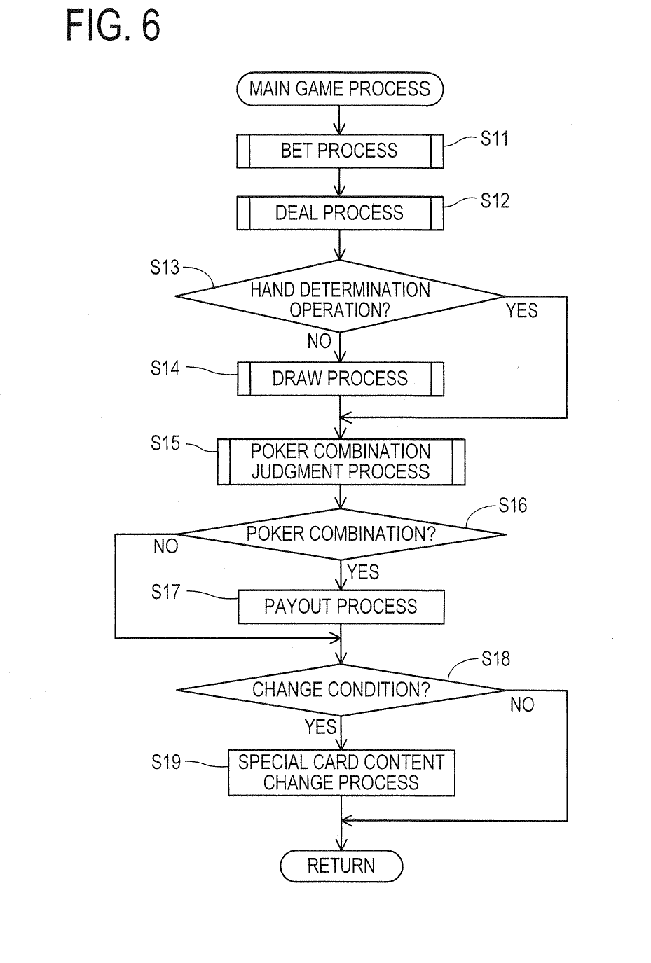

Then, the main CPU 41 executes a main game process (S2). The main CPU sequentially reads out the game programs thus authenticated from the RAM 43 and then executes. In the main game process (S2), the main CPU 41 executes the main game process program thus authenticated (refer to FIG. 6). The poker game executed in the poker gaming machine 1 is carried out by executing the main game process program (refer to FIG. 6). The main game process program is repeatedly executed while power is being supplied to the poker gaming machine 1.

Next, the main game process program in the poker gaming machine 1 will be described in detail while referring to the drawings. FIG. 6 is a flow chart of the main game process program.

Once execution of the main game process program is started, the main CPU 41 first executes a bet process. In this bet process (S11), the main CPU 41 executes the bet process program as will be described later. In this bet process (S11), the main CPU 41 accepts a bet of a gaming value with respect to a unit game. The bet process (S11) will be described in detail in the following text. Once the bet process (S11) is ended, the main CPU 41 shifts the flow to step S12.

At step S12, the main CPU 41 executes a deal process. In this deal process (S12), the main CPU 41 executes a deal process program as will be described later. Then, the main CPU 41 determines the cards that will constitute the player's hand by lottery. At this time, the main CPU 41 determines the cards that will constitute the player's hand from the deck including the trump cards and a special card 100. The main CPU 41 then deals five cards that constitute a player's hand to the player (refer to FIG. 9), and discloses to the player the constitution of the player's hand that was dealt (refer to FIG. 10). The deal process (S12) will be described in detail later. Once the deal process (S12) is ended, the main CPU 41 shifts the flow to step S13.

After shifting to step S13, the main CPU 41 judges whether or not the hand determination operation has been carried out. The hand determination operation is a particular type of operation with respect to the touch panel 11 and the control panel 20. The hand determination operation is an operation that the player carries out if a determination is made with respect to establishment of a poker combination without exchanging cards that constitute the player's hand which were dealt in the deal process (S12). Accordingly, the main CPU 41 executes the determination process at step S3 based on the operation signal from the touch panel 11 and the control panel 20. If the hand determination operation has been carried out (S13: YES), the main CPU 41 shifts the flow to step S15. Alternatively, if the hand determination operation has not been carried out (S13: NO), the main CPU 41 shifts the flow to step S14.

At step S14, the main CPU 41 executes a draw process. In this draw process (S14), the main CPU 41 executes a draw process program as will be described later. In the draw process (S14), the main CPU 41 accepts the hold operation carried out by the user and draws (exchanges) the cards that were not held. This draw process (S14) will be later described in detail. The draw process (S14) determines the configuration of the player's hand. Once the draw process (S14) is ended, the main CPU 41 shifts the flow to step S15.

At step S15, the main CPU 41 executes a poker combination judgment process. In this poker combination judgment process (S15), the main CPU 41 executes a poker combination judgment process program. In this poker combination judgment process (S15), the main CPU 41 determines whether or not a poker combination has been established and determines the contents of the prize based on the established poker combination, based on the constitution of the player's hand thus determined and the payout table that will be described later (refer to FIG. 15). At this time, if the special card 100 is included in the player's hand, the main CPU 41 regards the special card 100 as a specific type trump card which is displayed on the first card type display portion 101 through the third card type display portion 103. Then, the main CPU 41 executes the poker combination judgment process in the above condition. The poker combination judgment process (S15) will be described in detail as follows. Once the poker combination judgment process (S15) is ended, the main CPU 41 shifts the flow to step S16.

At step S16, the main CPU 41 judges whether or not the poker combination has been established in the player's hand. The main CPU 41 executes a judgment process at step S16 based on the judgment result of the poker combination judgment process (S15), which is stored in the RAM 43. If the poker combination has been established (S16: YES), the main CPU 41 shifts the flow to step S17. Alternatively, if the poker combination has not been established (S16: NO), the main CPU 41 shifts the flow to step S18.

After shifting to step S17, the main CPU 41 executes a payout process. In this payout process (S17), the main CPU 41 awards a prize to the player based on the poker combination established in the player's hand and the amount of gaming values that were bet in the unit game. More specifically, the main CPU 41 calculates the payout contents in the current unit game based on the judgment results of the poker combination judgment process (S15) which have been stored in the RAM 43. Then, the main CPU 41 adds up the number of coins corresponding to the payout contents thus calculated and regards the result as credits. At this time, the main CPU 41 controls the graphic board 68 and changes the credit amount of the credit amount display portion 121. The main CPU 41 can also pay out coins corresponding to the payout contents, to the coin payout port 23. Further, the main CPU 41 can make the ticket printer 30 print the bar code showing the number of coins corresponding to the payout contents. Thus, the main CPU 41 can award a prize through the bar code ticket 25.

At step S18, the main CPU 41 judges whether or not the change conditions have been established in the current unit game. The change conditions are conditions for changing the type of the trump card with respect to which the special card 100 functions as a wild card. The change conditions in this poker gaming machine 1 is the case a “ROYAL STRAIGHT FLUSH” poker combination is established in a player's hand which does not include a special card 100, in the previous unit game. Accordingly, the main CPU 41 makes the judgment at step S18 by referencing the judgment results of the poker combination judgment process (S15) which have been stored in the RAM 43. If the change condition has been established (S18: YES), the main CPU 41 shifts the flow to step S19. Alternatively, if the change condition has not established (S18: NO), the main CPU 41 terminates the main game process program as is. As was described hereinbefore, once the main game process program is ended, the main CPU 41 starts execution of the main game process program once again.

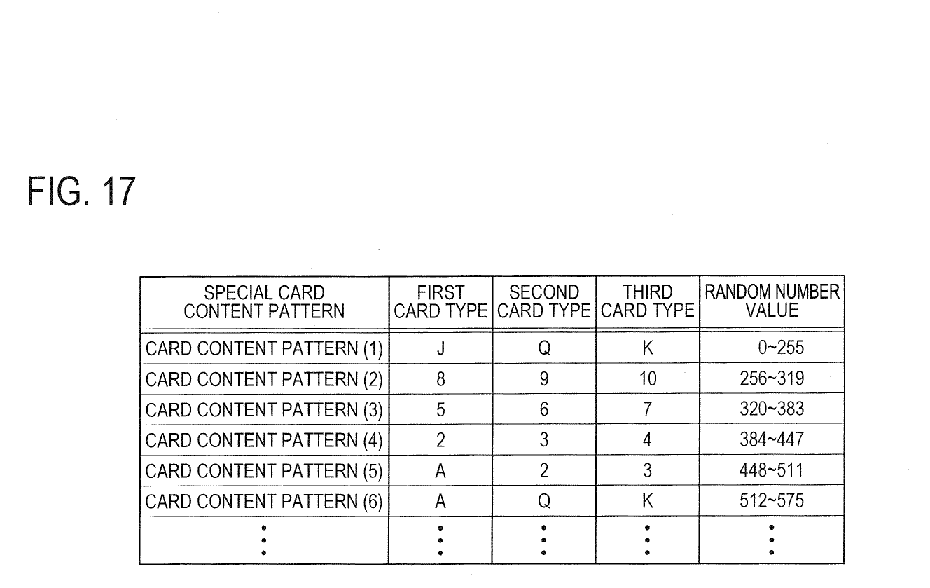

After shifting to step S19, the main CPU 41 executes a special card content change process. In this special card content change process (S19), the main CPU 41 executes the lottery program included in the game programs and samples one random number value from a predetermined random number range. The CPU 41 determines the type of trump cards with respect to which the special card 100 functions as a wild card based on the random number value thus sampled and the special card content determination table (refer to FIG. 17). After storing the card contents thus determined in the RAM 43, the main CPU 41 terminates the main game process program.

Here, as shown in FIG. 19, the special card content determination table specifies a plurality of types of card content patterns and a random number value range corresponding to each card content pattern. The card content patterns each include the number of the trump card that will be regarded as the first card type, the number of the trump card that will be regarded as the second card type and the number of the trump card that will be regarded as the third card type. Accordingly, if the card content pattern is changed, the main CPU 41 can change the first card type, the second card type and the third card type with respect to which the special card 100 functions as the wild card.

For instance, if the card content pattern is changed to the “card content pattern (5)” based on the random number value thus sampled, the special card 100 functions as a wild card with respect to the trump card having numbers “A”, “2” or “3” in subsequent poker games. In this case, at step S19, the display for first card type display portion 101 of the special card 100 is changed to letter “A” that shows the first card type. Similarly, the respective displays for the second card type display portion 102 and the third card type display portion 103 are also changed to numbers “2” and “3”, respectively.

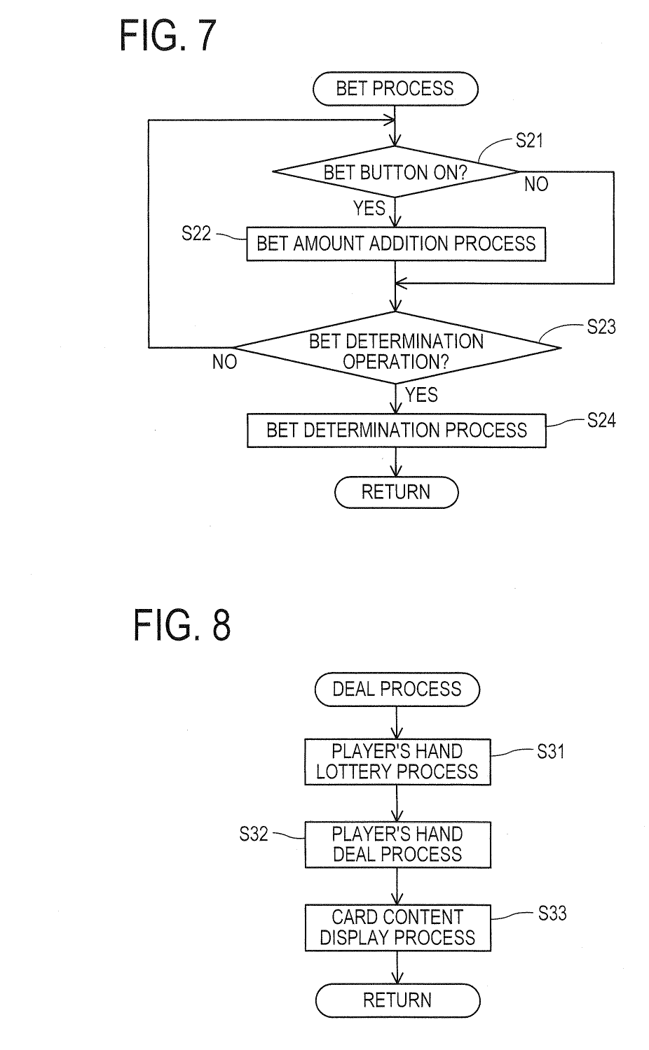

Next, the bet process program in the poker gaming machine 1 will be described in detail while referring to the drawings. FIG. 7 is a flow chart of a bet process program. In the following description, it is assumed that the player has already inserted coins or bills in the poker gaming machine 1.

After shifting to the bet process (S11), the main CPU 41 judges whether or not the BET button (specifically, 1-BET button 16, MAX-BET button 17) has been depressed (S21). The main CPU 41 makes the judgment at step S21 based on an operation signal generated by operating the 1-BET button 16 and the MAX-BET button 17. If the bet button has been depressed (S21: YES), the main CPU 41 shifts the flow to step S22. Alternatively, if the bet button has not been depressed (S21: NO), the main CPU 41 shifts the process to step S23.

After shifting to step S22, the main CPU 41 executes a bet amount addition process. In this bet amount addition process (S22), the main CPU 41 adds a value in accordance with the bet button that was depressed to the bet amount in the current unit game. Specifically, when the 1-BET button 16 is operated, the main CPU 41 adds “1” to the current bet amount stored in the RAM 43. Alternatively, when the MAX-BET button 17 is operated, the main CPU 41 sets the bet amount with respect to the current unit game which has been stored in the RAM 43 to “40”, which is the MAX-BET number. Once the BET amount addition process (S22) is ended, the main CPU 41 shifts the process to step S23.

At step S23, the main CPU 41 judges whether or not the bet determination operation has been carried out. This bet determination operation is an operation to determine an execution of the current unit game with the current bet amount. More specifically, the player's operation of the START button 13 corresponds to the bet determination operation. Accordingly, the main CPU 41 makes the judgment at step S23 based on the operation signal generated upon operating the START button 13. If the bet determination operation has been carried out (S23: YES), the main CPU 41 shifts the process to step S24. Alternatively, if the bet determination operation is not carried out (S23: NO), the main CPU 41 reverts the flow to step S21. As a result, the player can correct the bet amount with respect to the current unit game.

After shifting to step S24, the main CPU 41 executes the bet determination process. In this bet determination process (S24), the main CPU 41 determines the current bet amount stored in the RAM 43 to be the bet amount with respect to the current unit game. Once the bet determination process is ended, the main CPU 41 terminates the bet process program.

Next, the deal process program executed in the deal process (S12) will be described in detail while referring to the drawings. FIG. 8 is a flow chart of the deal process program.

After shifting to the deal process (S2), the main CPU 41 first executes the player's hand lottery process (S31). In the player's hand lottery process (S31), the main CPU 41 determines the plurality of cards that can constitute the player's hand from the deck including the trump cards and the special card 100, by lottery. The plurality of cards that can constitute this player's hand are made up of two different groups of cards: five cards dealt in the player's hand deal process (S32) that will be described later (hereinafter referred to dealt cards); and five cards that can be replaced in the draw process (S3) (hereinafter referred to re-dealt cards). More specifically, the main CPU 41 executes a lottery program to sample the random number value from the predetermined random number value range. The main CPU 41 determines ten cards that can constitute the player's hand based on the random number value thus sampled and the lottery table stored in the memory card 53. At this time, the five cards that make up the re-dealt cards are associated to five cards which are the respective dealt cards. Once the player's hand lottery process (S31) is ended, the main CPU 41 shifts the flow to step S32.

After shifting to step S32, the main CPU 41 executes the player's hand deal process. In this player's hand deal process (S32), the main CPU 41 deals the five deal cards that were determined in the player's hand lottery process (S31), to the player. More specifically, the main CPU 41 first transmits the deal screen display signal to the graphic board 68. As a result of transmitting this deal image display signal, the deal screen is displayed on the lower image display panel 6 (refer to FIG. 9). Specifically, the lower image display panel 6 displays an animated character image 123 that deals five cards. Once the player's hand deal process (S32) is ended, the main CPU 41 shifts the process to step S33.

At step S33, the main CPU 41 executes a card content display process. In the card content display process (S33), the main CPU 41 references the lottery results of the player's hand lottery process (S31) stored in the RAM 43. The main CPU 41 transmits the card content display signal based on the lottery results. As a result, the lower image display panel 6 displays the contents of five cards which are the dealt cards (specifically, number and suit) (refer to FIG. 10). After the contents of the cards that make up the dealt cards have been displayed, the main CPU 41 ends the deal process program.

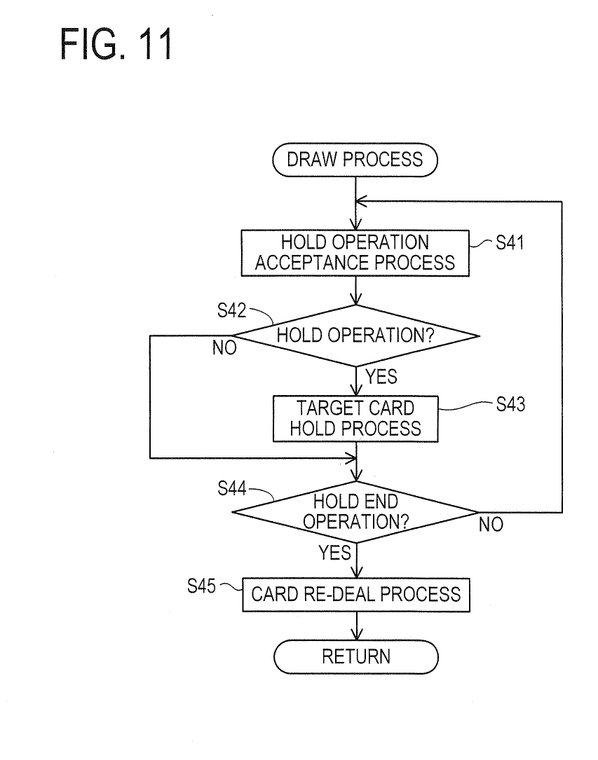

Next, the draw process program which is executed in the draw process (S14) will be described in detail while referring to the drawings. FIG. 11 is a flow chart of the draw process program.

After shifting to the draw process (S14), the main CPU 41 executes the hold operation acceptance process (S41). As was described earlier, in the hold operation, the player selects the cards that will remain in his/her hand from the five cards that were dealt and that make up the player's hand. Then, the hold operation is carried out by operating the first hold button 91 through the fifth hold button 95. Accordingly, the main CPU 41 accepts the player's hold operation based on the operation signals from the first hold button 91 through the fifth hold button 95.

In the following step S42, the main CPU 41 judges whether or not the hold operation has been carried out by the player. More specifically, the main CPU 41 makes the determination at step S42 based on the control signals generated by operating the first hold button 91 through the fifth hold button 95. If the hold operation has been carried out (S42: YES), the main CPU 41 shifts the flow to step S43. Alternatively, if the hold operation has not been carried out (S42: NO), the main CPU 41 shifts the flow to step S44.

At step S43, the main CPU 41 executes a target card hold process. In the target card hold process (S43), the main CPU 41 sets a card(s), from amongst the five cards that make up the current player's hand, which correspond(s) to the hold operation carried out in the hold operation acceptance process (S41) to remain in his/her hand. Setting of the cards to remain in hand is referred to as “setting for hold”. In the example shown in FIG. 12, if the third hold button 93 has been depressed, the main CPU 41 carries out setting for hold with respect to the “2 of diamonds” card positioned immediately above the third hold button 93. This process is similar to the case in which another hold button has been operated. Once the target card hold process (S43) is ended, the main CPU 41 shifts the flow to step S44.

If the setting for hold has not been carried out in the target card hold process (S43), the main CPU 41 transmits the hold display signal to the graphic board 68. As a result, the lower image display panel 6 displays the character string “HELD” showing that setting for holding has been made, on the card that was set for holding.

At step S44, the main CPU 41 judges whether or not the hold end operation has been carried out. The hold end operation indicates replacement of cards which were not set for holding, once the hold operation is ended. Specifically, the hold end operation is carried out by operating the CARD EXCHANGE button 18. Accordingly, the main CPU 41 carries out the judgment process at step S44 based on the operation signal generated as a result of operating the CARD EXCHANGE button 18. If the hold end operation has been carried out (S44: YES), the main CPU 41 shifts the process to step S45. Alternatively, if the hold end operation has not been carried out (S44: NO), the main CPU 41 reverts the flow to process S41. In this case, the player can add a card which is set for holding.

At step S45, the main CPU 41 executes the card re-deal process. In the card re-deal process (S45), the main CPU 41 exchanges the cards that constitute the player's hand based on the lottery result of the player's hand lottery process (S31) and the set contents of the target card hold process. Specifically, the main CPU 41 exchanges the card(s) which was (were) not set for holding, from amongst the cards constituting the player's hand, for a card(s) corresponding to the above card(s) included in the re-dealt cards. Once the card re-deal process (S45) is ended, the main CPU 41 ends the draw process program. The player's hand constitution is set when the card re-deal process (S45) is ended.

More specifically, the contents of the card re-deal process will now be described. As was described earlier, the player's hand lottery process (S31) determines the five dealt cards and the five re-dealt cards. Then, the cards that constitute the re-dealt cards are each associated to any one of the cards constituting the dealt cards, respectively (refer to FIG. 13). When the flow shifts to the card re-deal process (S45), the main CPU 41 can identify the cards which are set for holding (specifically, the cards that will remain in hand) and the cards which are not set for holding (specifically, the cards that will be drawn), from amongst the cards constituting the player's hand.

Accordingly, in the card re-del process (S45), the main CPU 41 can identify the card which was not set for holding, from amongst the cards constituting the player's hand. Then, the main CPU 41 can exchange the identified card which was not set for holding for one re-dealt card corresponding to this card (refer to FIG. 13).

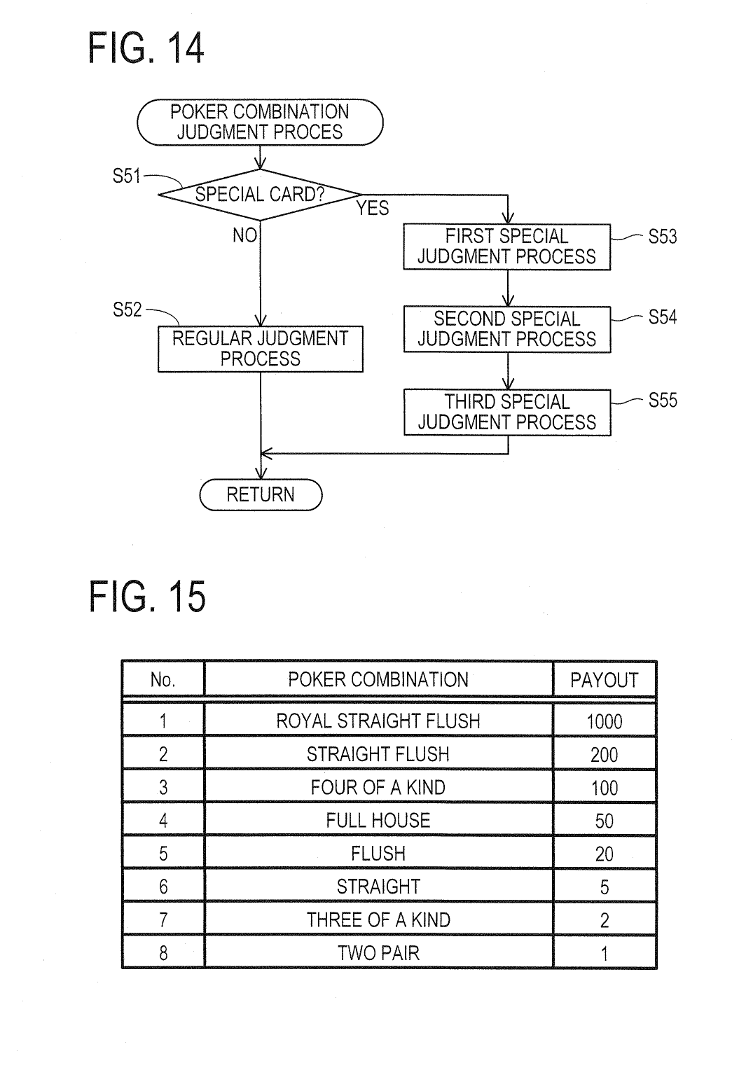

Next, the poker combination judgment process program to be executed in the poker combination judgment process (S15) will be described in detail while referring to the drawings. FIG. 14 is a flow chart of the poker combination judgment process program.

After shifting to the poker combination judgment process (S15), the main CPU 41 first judges whether or not the special card 100 is included in the player's hand (S51). More specifically, the main CPU 41 first identifies the contents (for instance, number and suit) of the five cards which constitute the player's hand at present. Specifically, the main CPU 41 identifies the contents of the five cards that constitute the player's hand based on the lottery result of the player's hand lottery process (S31) that has been stored in the RAM 43 and the re-deal result of the card re-deal process (S45). The main CPU 41 judges whether or not the special card 100 is included in the player's hand based on the contents of the identified five cards. If the special card 100 is included in the player's hand (S51: YES), the main CPU 41 shifts the flow to step S53. Alternatively, if the special card 100 is not included in the player's hand (S51: NO), the main CPU 41 shifts the flow to step S52.

At step S52, the main CPU 41 executes a regular judgment process. This regular judgment process (S52) is executed in the case the player's hand consists of trump cards. Accordingly, the main CPU 41 determines the poker combination established with the player's hand which consists of trump cards and the payout contents based on the player's hand.

More specifically, the main CPU 41 executes a regular judgment process (S52) based on the contents of the identified cards constituting the player's hand at present and the payout table (refer to FIG. 15).

Here, the payout table in the poker gaming machine 1 will be described in detail while referring to the drawings. FIG. 15 is an explanatory diagram with respect to the payout table.

The payout table specifies each poker combination and the corresponding payout contents. Here, the “poker combination” is constituted of “ROYAL STRAIGHT FLUSH”, “STRAIGHT FLUSH”, “FOUR OF A KIND”, “FULL HOUSE”, “FLUSH”, “STRAIGHT”, “THREE OF A KIND” and “TWO PAIR” (refer to FIG. 15). The details of these poker combinations are already known in the art, and therefore, further description thereof is hereby omitted.

The payout table specifies the payout contents that will be awarded with respect to 1 bet amount in the case the poker combination has been established. For instance, if the poker combination “FLUSH” has been established in the player's hand, 20 coins or credits corresponding to this coin amount will be awarded with respect to 1 bet amount. Corresponding awards are also granted for the other poker combinations, as is the case with the above-described example, and therefore, further description thereof is omitted.

In the regular judgment process (S52), the main CPU 41 judges whether or not the poker combination shown in FIG. 15 is established in the player's hand, based on the contents (number and suit) of the cards constituting the current player's hand. If the poker combination is established in the player's hand, the main CPU 41 determines the payout contents with respect to the player's hand based on the bet amount in the current unit game and the payout table (refer to FIG. 15). Alternatively, if the poker combination is not established in the player's hand, the main CPU 41 sets the payout contents with respect to the player's hand to “0”. After storing the payout contents with respect to the player's hand in the RAM 43, the main CPU 41 ends the poker combination judgment process program.

Alternatively, If the special card 100 is included in the player's hand, the main CPU 41 executes the first special judgment process (S53). In the first special judgment process (S53), the main CPU 41 determines the poker combination established in the player's hand and the payout contents based on the player's hand, like is the case with the regular judgment process (S52).

In the first special judgment process (S53), the main CPU 41 regards the special card 100 included in the player's hand as a trump card that has a number displayed on the first card type display portion 101 and four types of suits. For instance, if the contents of the special card 100 correspond to the “card content pattern (1)” which is the initial setting, the main CPU 41 regards the special card 100 included in the player's hand as a trump card having the number “J” which is the first card type and any of the four types of suits (refer to FIG. 17).

The first special judgment process (S53) is similar to the above-described regular judgment process (S52), except for the point that the special card 100 is regarded as a “trump card having a number corresponding to the first card type and four types of suits”. After storing in the RAM 43 the judgment result for the case that the special card 100 is regarded as “a trump card having a number corresponding to the first card type and four types of suits”, the main CPU 41 shifts the process to step S54.

After shifting to step S54, the main CPU 41 executes the second special judgment process. In the second special judgment process (S54), the main CPU 41 determines the poker combination established in the player's hand and the payout contents based on this player's hand, like is the case with the first special judgment process (S53).

In the second special judgment process (S54), the main CPU 41 regards the special card 100 included in the player's hand as a trump card having a number displayed on the second card type display portion 102 and four types of suits. For instance, if the contents of the special card 100 correspond to the “card content pattern (1)” which is the initial setting, the main CPU 41 regards the special card 100 included in the player's hand as a trump card having the number “Q” which corresponds to the second card type and any of the four types of suits (refer to FIG. 17).

The second special judgment process (S54) is similar with the above-described regular judgment process (S52), except for the point that the special card 100 is regarded as a “trump card having a number which corresponds to the second card type and four types of suits”. After storing in the RAM 43 the judgment result for the case that the special card 100 is regarded as “a trump card having a number corresponding to the second card type and four types of suits”, the main CPU 41 shifts the flow to step S55.

At step S55, the main CPU 41 executes the third special judgment process. In the third special judgment process (S55), the main CPU 41 determines the poker combination established in the player's hand and the payout contents based on this player's hand, like is the case with the first special judgment process (S53) and the second special judgment process (S54).

In the third special judgment process (S55), the main CPU 41 regards the special card 100 included in the player's hand as a trump card having a number displayed on the third card type display portion 103 and four types of suits. For instance, if the contents of the special card 100 correspond to the “card content pattern (1)” which is the initial setting, the main CPU 41 regards the special card 100 included in the player's hand as a trump card having the number “K” which corresponds to the third card type and any of the four types of suits (refer to FIG. 17).

The third special judgment process (S54) is similar with the above-described regular judgment process (S52), except for the point that the special card 100 is regarded as a “trump card having a number which corresponds to the third card type and four types of suits”. After storing in the RAM 43 the judgment result for the case that the special card 100 is regarded as “a trump card having a number corresponding to the third card type and four types of suits”, the main CPU 41 ends the poker combination judgment process program.

As was described above, if the poker combination judgment process (S15) is ended and the poker combination is established in the player's hand, the main CPU 41 executes the payout process (S17). Then, in the payout process (S17), the main CPU 41 awards a payout based on the player's hand to the player, based on the judgment result of the poker combination judgment process program. Thus, if the special card 100 is included in the player's hand, the main CPU 41 awards to the player a payout with respect to all poker combinations that were established, based on the judgment result of the first special judgment process (S53), the second special judgment process (S54) and the third special judgment process (S55).

If the special card 100 has been included in the player's hand, in the payout process (S17), the poker combination with the highest payout can be awarded from amongst all poker combinations which have been established in the first special judgment process (S53), the second special judgment process (S54) and the third special judgment process (S55).

As was described earlier, the poker gaming machine 1 and the poker game playing method employ a special card 100, in addition to the trump cards in the poker game. The special card functions as a wild card with respect to a portion of the special type trump cards from amongst all types of trump cards. Accordingly, a case occurs in which the strategy (for instance, strategy with respect to holding and drawing cards) in the poker game having a wild card that functions with respect to all trump cards does not work. As a result, the player needs to employ a new strategy with respect to holding and drawing cards. Accordingly, employing of a special card 100 in the poker gaming machine 1 can offer new strategy characteristics with respect to the poker game.

If a predetermined change condition is satisfied, the poker gaming machine 1 and the poker game playing method changes the contents of the special card. Specifically, since the type of the trump card with respect to which the special card 100 functions as a wild card is changed, the player needs to change his/her strategy with respect to holding and drawing the special card 100. As a result, the poker gaming machine 1 and the poker game playing method can offer interest such as changing the strategy, which could not be successfully achieved in the conventional art.

The present invention is not limited to the above-described embodiment and various modifications and alterations can be made thereto without departing from the scope of the present invention. For instance, the type of the trump cards with respect to which the special card 100 functions as a wild card is not limited to a trump card having 3 types of numbers allotted thereto. Specifically, the special card 100 may function as a wild card with respect to a portion of specific type trump cards from amongst all trump cards.

The type of the trump cards with respect to which the special card 100 functions as a wild card is not limited to numbers alone. Specifically, the type of trump cards which function as wild cards can be identified by “suit only”. Further, the type of trump cards that function as a wild card may also be identified by the number and suit.

Then, the deck of cards employed in the poker game may include the trump cards and the special card 100. Specifically, the deck may contain one special card 100 or a plurality of special cards 100.

Further, the change condition for the contents of the special card 100 (type of the trump card that functions as the wild card) may be other than establishment of a poker combination based on a predetermined pattern. Specifically, the change condition may include various other conditions. For example, the number of unit games for the poker game that the player carried out in the poker gaming machine 1 may also be used as the change condition. Also, the lapse of activation time of the poker gaming machine 1 may also be used as a change condition. Further, the payout rate in the poker gaming machine 1 can also be employed as the change condition.

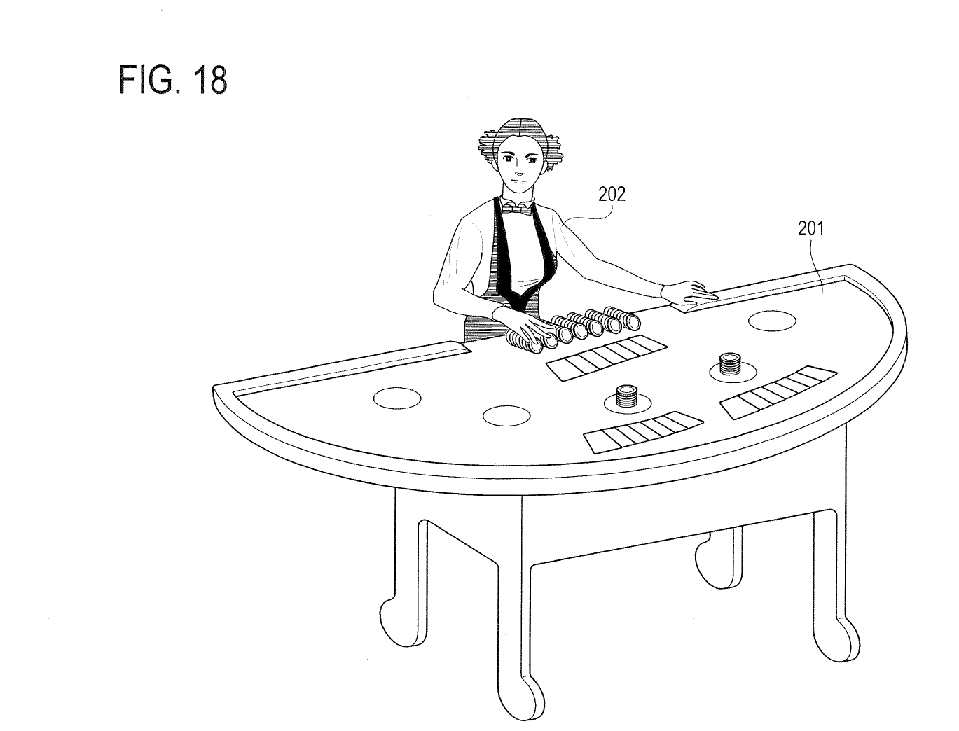

As shown in FIG. 18, the poker game playing method can also be employed with respect to poker (so-called table game) carried out by a dealer 202 and a player(s) (not shown) on the game table 201.

In the table game in this case, the dealer 202 prepares a card deck and deals five cards that constitute a player's hand to the player at the game table 201. The card deck is constituted of trump cards and special card 100.

The player places a bet by placing a chip(s) at a predetermined location on the game table 201. The progress of the poker game (hold, draw and the like) is similar to the playing method in the poker gaming machine 1.

Then, if the player's hand included the special card 100, the dealer 202 regards the special card 100 as a trump card which is identified by being displayed on the first card type display portion 101 through the third card type display portion 103, thereby determining the poker combination.

If the change condition has been satisfied, the dealer 202 replaces the special card 100 which is included in the card deck for a special card of a different type (specifically, a special card of three different types, including the first card type through the third card type).

Further, the present invention can be applied to a card gaming machine and a card game playing method for carrying out a card game such as Blackjack or Baccarat or the like.

The present invention can be realized as a playing method for executing the processes described above. Further, the present invention can also be realized as a program for causing the computer to execute the playing method and a recording medium onto which this program is recorded.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A poker gaming machine that executes a poker game using trump cards, the poker gaming machine having:
a display that displays a plurality of cards; and
a processor that executes processes as follows:
(a) a process of accepting a bet of a gaming value placed by the player;
(b) a process of determining a player's hand which is made up of five cards from a card group including the trump cards and a special card which is regarded as a specific type trump card constituting one portion of all types of trump cards;
(c) a process of determining whether or not the player's hand thus determined constitutes a poker combination;
(d) a process of judging whether or not the player's hand constitutes a poker combination, in a case where the special card is included in the player's hand on supposition that the special card is the specific type trump card; and
(e) a process of awarding, if the player's hand constitutes a poker combination, a payout corresponding to the poker combination thus constituted.

2. The poker gaming machine according to claim 1, wherein, if a predetermined condition with respect to a poker game is satisfied, the processor executes a process of determining the type of the trump cards which make up said specific types from all card types making up the trump cards.

3. A poker gaming machine that executes a poker game using trump cards, the poker gaming machine having:
a display that displays a plurality of cards; and
a processor that executes processes as follows:
(a) a process of accepting a bet of a gaming value placed by the player;
(b) a process of determining a player's hand which is made up of five cards, from a card group including the trump cards and a special card which is regarded as a specific type trump card with any of characters “J”, “Q” and “K” that constituting one portion of all types of trump cards;
(c) a process of determining whether or not the player's hand thus determined constitutes a poker combination;
(d) a process of judging whether or not the player's hand constitutes a poker combination, in a case where the special card is included in the player's hand on supposition that the special card is the specific type trump card with any of characters “J”, “Q” and “K”; and
(e) a process of awarding, if the players hand constitutes a poker combination, a payout corresponding to the poker combination thus constituted.

4. A poker game playing method for playing a poker game using trump cards, the poker game playing method having:
(a) a step of accepting a bet of a gaming value placed by the player;
(b) a step of determining a player's hand which is made up of five cards from a card group including the trump cards and a special card which is regarded as a specific type trump card constituting one portion of all types of trump cards;
(c) a step of determining whether or not the player's hand thus determined constitutes a poker combination;
(d) a step of judging whether or not the player's hand constitutes a poker combination, in a case where the special card is included in the player's hand on supposition that the special card is the specific type trump card; and
(e) a step of awarding, if the player's hand constitutes a poker combination, a payout corresponding to the poker combination thus constituted.

5. The poker game playing method according to claim 4, further comprising: a step of determining the type of the trump cards which make up said specific types from a all card types making up the trump cards, if a predetermined condition with respect to a poker game is satisfied.

6. A poker game playing method for playing a poker game using trump cards, the poker game playing method comprising:
(a) a step of accepting a bet of a gaming value placed by the player;
(b) a step of determining a player's hand which is made up of five cards, from a card group including the trump cards and a special card which is regarded as a specific type trump card with any of characters “J”, “Q” and “K” constituting one portion of all types of trump cards;
(c) a step of determining whether or not the player's hand thus determined constitutes a poker combination;
(d) a step of judging whether or not the player's hand constitutes a poker combination, in a case where the special card is included in the player's hand on supposition that the special card is the specific type trump card with any of characters “J”, “Q” and “K”; and
(e) a step of awarding, if the player's hand constitutes a poker combination, a payout corresponding to the poker combination thus constituted.
